(19) United States
(12) Patent Application Publication
(10) Pub. No.: US 2012/0102725 A1
(43) Pub. Date: May 3, 2012

(54) Battery Separator

(75) Inventors: Timothy J. Fuller, Pittsford, NY (US); James Mitchell, Bloomfield, NY (US)

(73) Assignee: GM GLOBAL TECHNOLOGY OPERATIONS, INC., Detroit, MI (US)

(21) Appl. No.: 12/913,955

(22) Filed: Oct. 28, 2010

(51) Int. Cl. H01M 2/16

(52) U.S. Cl. 29/623.1

(57) ABSTRACT

Resinous fibers of nanometer to micrometer width dimensions are drawn from a multi-component system by a melt extrusion process. The process includes a step of combining a fiber resin with a water-soluble carrier resin to form a resinous mixture. The resinous mixture is extruded to form an extruded resinous mixture, the extruded resinous mixture having strands of the fiber resin with the carrier resin. The extruded resinous mixture is then contacted with water to separate the strands of the fiber resin from the carrier resin. A fibrous sheet is then formed from the strands of fiber resin. The fibrous sheets are useful in filtration, as battery separators in Li ion batteries and as diffusion layers in fuel cells.

### FIELD OF THE INVENTION

The present invention relates to porous pads that are useful in filtration and as separators for battery and fuel cell applications.

### BACKGROUND OF THE INVENTION

High quality porous pads are used for filtration and in a number of electronic devices such as batteries and fuel cells. In such devices, the porous pads advantageously allow gases or components dissolved in liquids to pass through. Porous pads are made of micro-fibers, nano-fibers, and micro-porous films. Fibers of these dimensions are prepared by electrospinning in the case of solvent soluble polymers. However, polyolefins are difficult to form solutions without maintaining high temperatures in high-boiling solvents. Porous polyolefins are made by biaxial tension on films or sheets of these plastic polymers. Alternatively, pore formers are added to the polyolefin sheets during the fabrication process which are then extracted by solvents or removed with heat. Electrospinning can be used in the case of solvent soluble olefins which can be processed in solutions.

In battery applications, such porous materials are used as separators. Battery separators are porous sheets that are interposed between an anode and cathode in a fluid electrolyte. For example, in lithium ion batteries, lithium ions (Li⁺) move from the anode to the cathode during discharge. The battery separator acts to prevent physical contact between the electrodes while allowing ions to be transported. Typical prior art separators include microporous membranes and mats made from nonwoven cloth. Battery separators are ideally inert to the electrochemical reactions that occur in batteries. Therefore, various polymers have been used to form battery separators.

In the case of fuel cells, gas diffusion layers play a multifunctional role in proton exchange membrane fuel cells. For example, gas diffusion layers act as diffusers for reactant gases traveling to the anode and the cathode layers while transporting product water to the flow field. Gas diffusion layers also conduct electrons and transfer heat generated at the membrane electrode assembly to the coolant, and acts as a buffer layer between the soft membrane electrode assembly and the stiff bipolar plates. Although the present technologies for making gas diffusion layers for fuel cell applications work reasonably well, improvement in properties and cost are still desirable.

Accordingly, the present invention provides improved methods of making porous pads that are useful in filtration, battery and fuel cell applications.

### SUMMARY OF THE INVENTION

The present invention solves one or more problems of the prior art by providing in at least one embodiment a method of forming a fibrous sheet that is useful in battery and in fuel cell applications. The method of this embodiment includes a step of combining a fiber-forming resin with a water-soluble carrier resin to form a resinous mixture. The resinous mixture is extruded to form an extruded resinous mixture. Characteristically, the extruded resinous mixture has strands of the fiber-forming resin within a larger strand of the carrier resin. The extruded resinous mixture is then contacted with water to separate the strands of the fiber-forming resin from the carrier resin. A fibrous sheet is then formed from the strands of fiber-forming resin. Finally, the fibrous sheet is integrated interposed between an anode and a cathode. The method is advantageously used to make miniscule fibers of polyolefins useful as porous supports and is amenable to the continuous, large scale, and inexpensive processing of low cost polymers and polymer fibers. The method lends itself to creating materials with customized thermal, dimensional, and chemical properties. It is readily scalable, reproducible and lends itself to continuous processing techniques with inexpensive, environmentally friendly components and manufacturing.

In another embodiment, a method of making a device with a fibrous sheet is provided. The method comprises combining a thermoplastic resin with a water-soluble polyamide resin to form a resinous mixture. The resinous mixture is then extruded to form an extruded resinous mixture, the extruded resinous mixture having strands of the thermoplastic resin within a larger strand of the water-soluble carrier resin. The extruded resinous mixture is contacted with water to separate the strands of the thermoplastic resin from the water-soluble polyamide (e.g. Nylon™) resin. A fibrous sheet is formed from the strands of the thermoplastic resin. Finally, the fibrous sheet is integrated and interposed between an anode and a cathode. The water soluble resin can be poly(2-ethyl-2-oxazoline) (PEOX), polyethyleneoxide (PEO), and the like.

### BRIEF DESCRIPTION OF THE DRAWINGS

Exemplary embodiments of the present invention will become more fully understood from the detailed description and the accompanying drawings, wherein:

FIG. 1A provides a schematic illustration of a battery system incorporating a separator;

FIG. 1B provides a schematic illustration of a fuel cell incorporating a separator;

FIG. 2 is an idealized top view of a fibrous plate or pad made by a variation of the method set forth below;

FIG. 3A is a schematic flow chart showing the fabrication of a separator plate for electric battery applications;

FIG. 3B is a schematic flow chart showing the fabrication of a gas diffusion layer for fuel cell applications;

FIG. 4A is an electron micrograph of the extruded PEOX-Polyethylene strands;

FIG. 4B is an electron micrograph of the fibers after the wash process; and

FIG. 4C provides an electron micrograph for a pressed mat of fibers.

### DESCRIPTION OF THE INVENTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

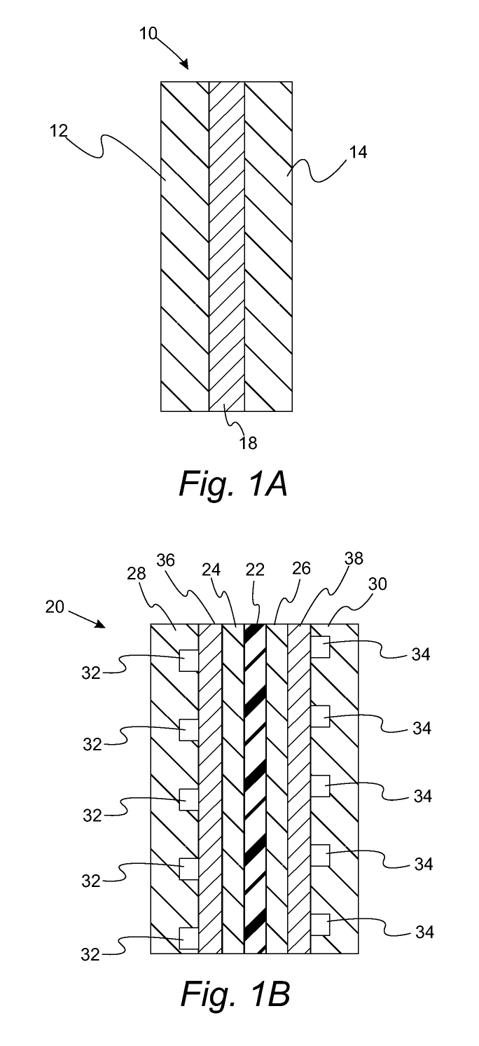

With reference to FIG. 1A, a schematic cross section of a battery assembly incorporating an embodiment of a fibrous sheet is provided. Battery 10 includes anode 12 and cathode 14. Separator 18 is interposed between anode 12 and cathode 14 thereby minimizing electrical shorts between the two electrodes while allowing passages of ions such as lithium (Li⁺). Advantageously, separator 18 is made by a variation of the process set forth below.

With reference to FIG. 1B, a schematic cross section of a fuel cell that incorporates an embodiment of a fibrous sheet is provided. PEM fuel cell 20 includes polymeric ion conducting membrane 22 disposed between cathode catalyst layer 24 and anode catalyst layer 26. Fuel cell 20 also includes bipolar electrically conductive plates 28, 30, gas channels 32 and 34, and gas diffusion layers 36 and 38. Advantageously, diffusion layers 36 and 38 are made by a variation of the process set forth below.

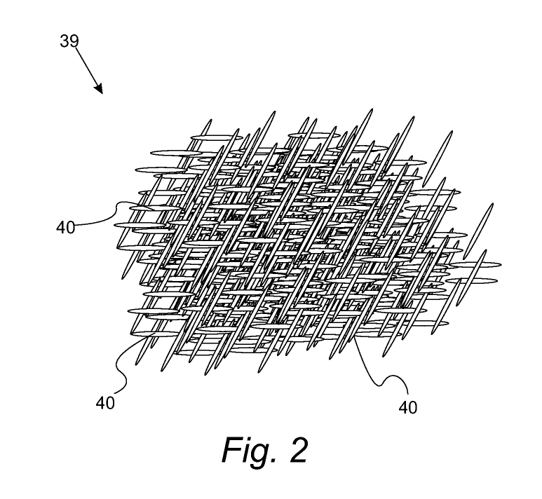

With reference to FIG. 2, an idealized top view of a fibrous sheet made by a variation of the method set forth below is provided. Fibrous sheet 39 is formed from a plurality of resinous fibers 40 aggregated together to form a pad. Typically, resinous fibers 40 have an average width from about 10 nanometers to about 30 microns. In another refinement, resinous fibers 40 have an average width of about 5 nanometers to about 10 microns. In still another refinement, resinous fibers 40 have an average width of from about 10 nanometers to about 5 microns. In still another refinement, resinous fibers 40 have an average width of from about 100 nanometers to about 5 microns.

In a variation of the present embodiment, fibrous sheet 39 has a thickness from about 50 microns to about 2 mm. In a refinement, fibrous sheet 39 has a thickness from about 50 microns to about 1 mm. In another refinement, fibrous sheet 39 has a thickness from about 100 microns to about 500 mm.

In a variation of the present invention, the fibrous sheet includes a wetting agent. Such a wetting agent may be added as a separate component or grafted onto a polymer backbone.

In another variation, the fibrous sheet includes voids that result in porosity. In a refinement, the porosity is from about 5 to 95 volume percent. In this context, porosity means the volume percent of the sheet that is empty. In another refinement, the porosity is from about 20 to 80 volume percent. In still another refinement, the porosity is from about 40 to 60 volume percent.

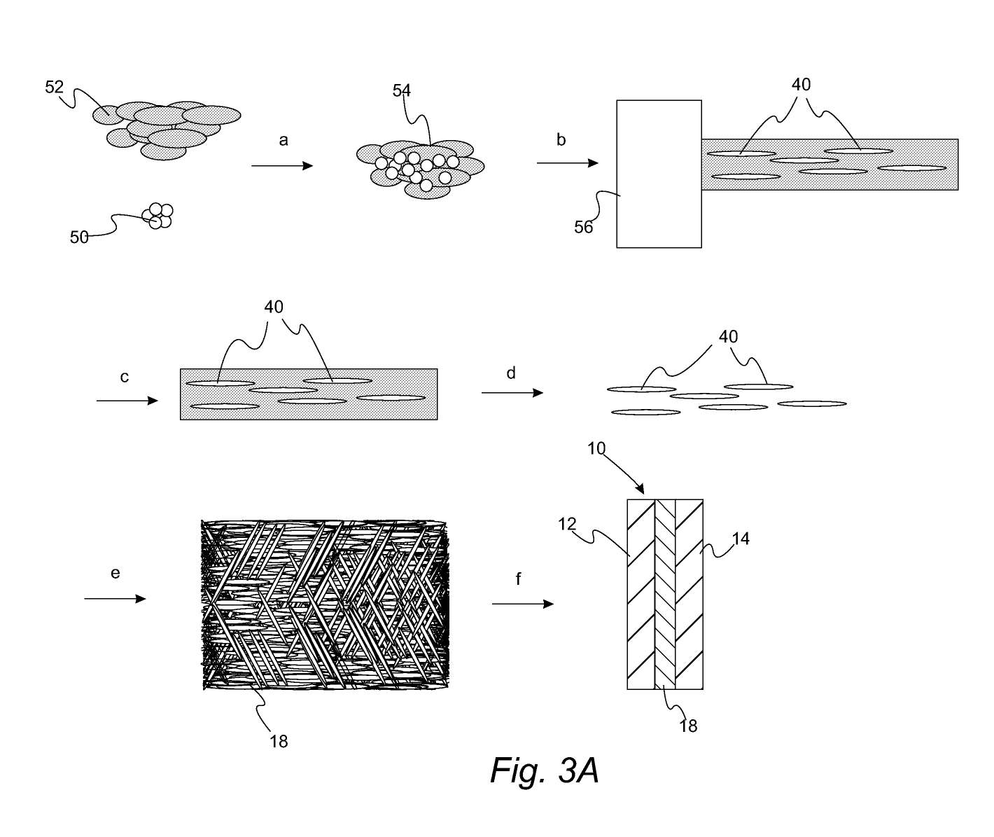

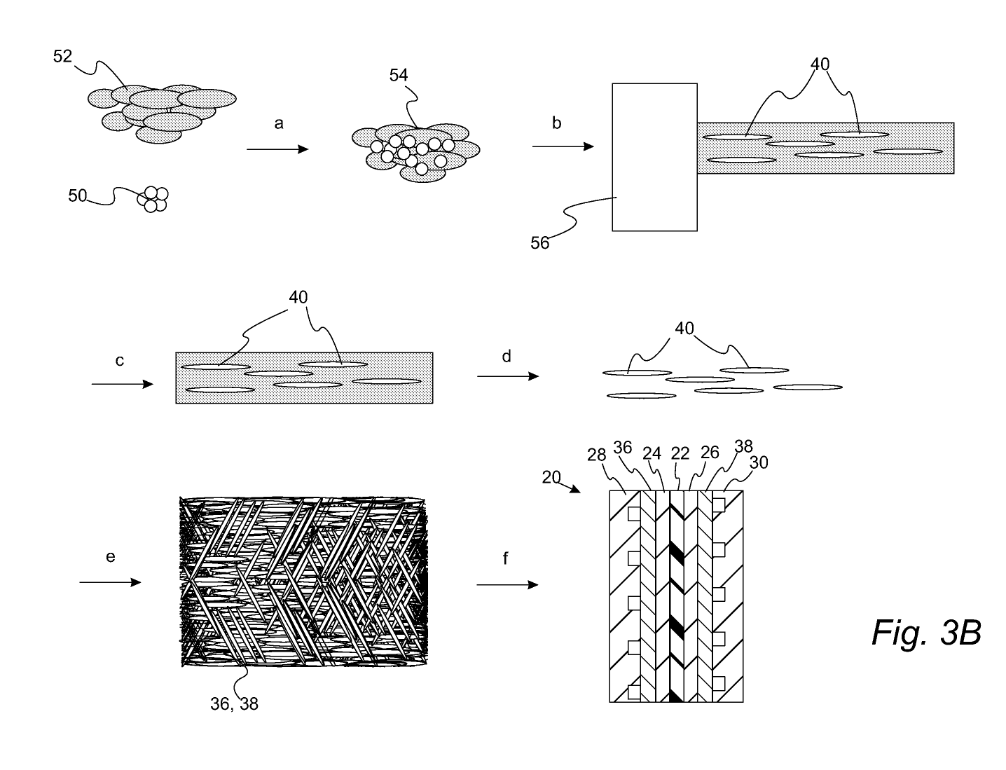

With reference to FIG. 3A, a schematic flow chart showing the fabrication of a separator porous fiber pad is provided. In step a), fiber-forming resin 50 is combined with a carrier resin 52 to form resinous mixture 54. In a refinement, the weight ratio of water-insoluble polymer to water-soluble PEOX is between 0.1 and 10. In another refinement, the weight ratio of water-insoluble polymer to water-soluble PEOX is between 0.2 and 0.8. Fiber resin 50 is the resin that will form resinous fibers 40 while carrier resin 52 is a water-soluble resin. In one refinement, fiber-forming resin 50 is a thermoplastic polymer.

Examples of suitable thermoplastic polymers include, but are not limited to, polyolefins, polyesters, and combinations thereof. Other examples include, but are not limited to, polyethylene, polypropylene, polybutene, polybutylene terephthalate, perfluorosulfonic acid polymers, perfluorocyclobutane polymers, polycycloolefins, polyperfluorocyclobutanes, polyamides (not water soluable), polylactides, acrylonitrile butadiene styrene, acrylic, ethylene-vinyl acetate, ethylene vinyl alcohol, fluoropolymers (e.g., PTFE, FEP, etc), polyacrylates, polyacrylonitrile (e.g., PAN, Acrylonitrile), polyaryletherketone, polybutadiene, polybutylene, polybutylene terephthalate, polycaprolactone, polychlorotrifluoroethylene, polyethylene terephthalate, polycyclohexylene dimethylene terephthalate, polycarbonate, polyhydroxyalkanoates, polyketone, polyetherketone, polyetherimide, polyethersulfone, polyethylenechlorinates, polymethylpentene, polyphenylene oxide, polystyrene, polysulfone, polytrimethylene terephthalate, polyurethane, polyvinyl acetate, polyvinyl chloride, polyvinylidene chloride, styrene-acrylonitrile, and combinations thereof. Examples of suitable water-soluble resins include, but are not limited to, water-soluble polyamides (e.g., poly(2-ethyl-2-oxazoline) (“PEOX”). In step b), the materials are co-extruded at an elevated temperature using extruder 56, with strands of the fiber-forming resin 50 forming in the carrier resin 52. In step c), the extruded strand is optionally separated from extruder 56. In step d), resinous fibers 40 are freed from the strand by washing in water. In step e), resinous fibers 40 are formed into separator 18 (FIG. 3A). Separator 18 may be formed by pressing and heating of fibers 40. In another refinement, fibers 40 are bonded to paper or a mat. Typically, separator 18 is pad shaped having a thickness from about 10 microns to 5 mm. Finally, separator 18 is placed between an anode and a cathode to form a battery with the separator therein (step f).

With reference to FIG. 3B, a schematic flow chart showing the fabrication of a separator plate is provided. In step a), fiber-forming resin 50 is combined with a carrier resin 52 to form resinous mixture 54. Fiber resin 50 is the resin that will form resinous fibers 40 while carrier resin 52 is a water-soluble resin. In one refinement, fiber-forming resin 50 is a thermoplastic polymer. Examples of suitable thermoplastic polymers and of water-soluble resins are the same as those set forth above. In step b), the materials are co-extruded at an elevated temperature using extruder 56, with strands of the fiber-forming resin 50 forming in the carrier resin 52. In step c), the extruded strand is optionally separated from extruder 56. In step d), resinous fibers 40 are freed from the strand by washing in water. In step e), resinous fibers 40 are formed into gas diffusion layers 36 and 38. Gas diffusion layers 36 and 38 may be formed by pressing and heating of fibers 40. In another refinement, fibers 40 are bonded to paper or a mat. Typically, gas diffusion layers 36 and 38 are pad shaped having a thickness from about 10 microns to 5 mm. Finally, gas diffusion layers 36 and 38 is place between an a bipolar plate and an anode layer or cathode layer in step f) to form a fuel cell with the gas diffusion layer contained therein. For optimal performance, gas diffusion layers are conductive such that electrons can pass from catalyst layer 24 (the anode) through the gas diffusion layer 36 to the bipolar plate 28 through a circuit (with load such as a motor) to the cathode plate 30 to the gas diffusion layer 38, to the cathode catalyst layer 26. In the case of polyacylonitrile, a conductive fibrous pad can be made by pryrolysis and carbonization or graphitization of the porous mats at temperatures in excess of 300° C. Conductivity can also be imparted to the fibers by introducing carbon black or graphite to the water-insoluble resin (by extrusion) at more than 7.5 wt. % loadings before extrusion with the water-soluble polymer (such as poly(2-ethyl-2-oxazoline).

In a refinement of the present invention, the fibers have an average cross sectional width (i.e., diameter when the fibers have a circular cross section) from about 10 nanometers to about 30 microns. In another refinement, the fibers have an average width of about 5 nanometers to about 10 microns. In still another refinement, the fibers have an average width of from about 10 nanometers to about 5 microns. In still another refinement, the fibers have an average width of from about 100 nanometers to about 5 microns. The length of the fibers typically exceeds the width. In a further refinement, the fibers produced by the process of the present embodiment have an average length from about 1 mm to about 20 mm or more. The fibers produced herein have a fiber diameter range between the two size ranges, usually less than those common to cellulose papers and other natural fiber membranes. Electro-spun fibers and expanded Teflon membranes (EPTFE) have fibers commonly in the low to mid 100's of nanometer range. Paper fibers, extruded strands and drawn fibers and threads are commonly in the 100's to thousands of microns in diameter.

The following examples illustrate the various embodiments of the present invention. Those skilled in the art will recognize many variations that are within the spirit of the present invention and scope of the claims.

### Example 1

### Extruded Micro- and Nano-Fibers of Low Molecular Weight Polyethylene

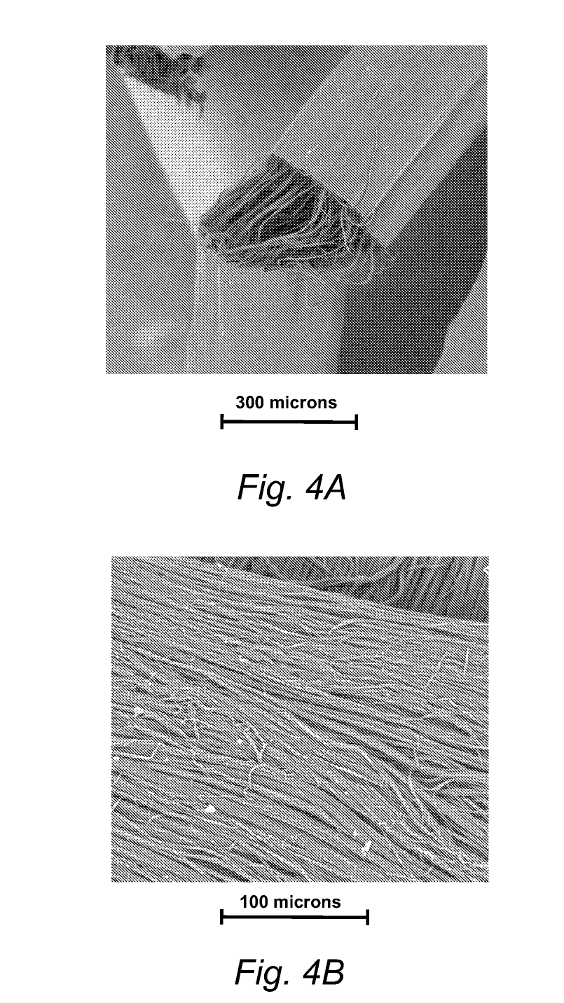

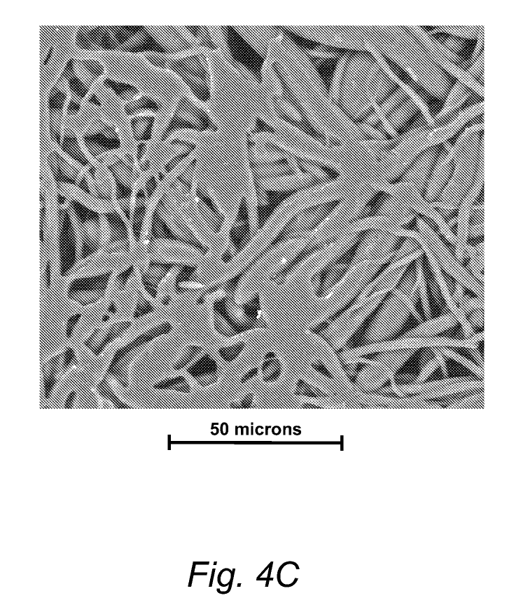

Polyethylene powder (7,700 Mn, 35,000 Mw, Aldrich catalog number 47799-1KG, 1 gram) is blended with poly(2-ethyl-2-oxazoline) (50,000 Mw, Aldrich 372846-500G, 9 grams) in a Waring blender. The powder is brushed into the hopper of a laboratory mixing extruder (Dynisco, LME) operated at 140° C. header and rotor set temperatures with the drive motor operated at 50% of capacity. The extrudate is drawn at 1 foot per second and is wound-up on a Dynisco Take-Up System (TUS). The resultant extruded strand (FIG. 4A) is suspended in 3-cups of water using a Waring blender with Variac control set at 30% of capacity. The poly(2-ethyl-2-oxazoline) dissolves away from the polyethylene nano- and micro-fibers that are between 500 nm and 10 microns in width and of undetermined length (but commonly greater than 1 mm long). The fibers are isolated by filtration, washed with water, filtered, and then suspended in isopropanol. FIG. 4B provides an image of the fibers. The fibers are filtered onto a polypropylene mat (SeFar America) and dried to yield 0.99 grams of miniscule fibers. The fibers (0.05 gram) are suspended in isopropanol and pressure filtered onto a 47-mm Millipore filter (Mitex LSWP) to yield a 50-micron mat of polyethylene fibers. The air-dried mat is compression molded at between 85 and 100° C. at between 0 and 2000 psi between Kapton release sheet (American Durofilm) for between 2 and 2.2 minutes (FIG. 4C). The air porosity of the resultant compressed fiber mat is between 0 and 3.3 cubic centimeters per second depending on process conditions (see Table 1) as determined with a Gurley apparatus. The compressed mat is used as a lithium ion battery separator in a button cell and the results compare favorably to those made with commercial lithium ion battery separators such as Entek Teklon Gold (PE) and Celgard 2700 (PP).

TABLE 1
Burley Apparatus Measurements for Porosity

| | Processing | Thickness | Gurley | Reprocessed | Gurley |
|---|---|---|---|---|---|
| Polymer | Conditions | μm | cc/sec | Conditions | cc/sec |
| 100% Low MW | 85° C./0 psi/2 min | 70 | 3.5 | 100° C./2000 psi/2.2 min | 1.80 |
| polyethylene | | | | | |
| 30 wt. % Low MW | 80° C./0 psi/2 min | 68 | 28.0 | 100° C./2000 psi/2.2 min | 0 |
| polyethylene | | | | | |
| 70 wt. % High MW | | | | | |
| polyethylene | | | | | |
| 50 wt. % Low MW | 90° C./0 psi/2 min | 68 | 6.7 | 100° C./2000 psi/2.2 min | 0 |
| polyethylene | | | | | |
| 50 wt. % High MW | | | | | |
| polyethylene | | | | | |
| 100% High MW | 90° C./0 psi/2 min | 77 | 3.0 | 100° C./2000 psi/2.2 min | 0.27 |
| polyethylene-3 | | | | | |
| 100% High MW | 95° C./0 psi/2 min | 250 | 5.2 | 100° C./2000 psi/2.2 min | 0.33 |
| polyethylene-2 | | | | | |
| 100% High MW | 85° C./0 psi/2 min | 88 | 31.5 | 100° C./2000 psi/2.2 min | 0.45 |
| polyethylene-1 | | | | | |
| Entek Teklon | | | 0 | | |
| Gold LP (PE) | | | | | |
| Celgard 2700 (PP) | | | 0 | | |

### Example 2

### Extruded Micro- and Nano-Fibers of Polyethylene

Nano- and micro fibers are obtained using a Glad sandwich bag (designated high MW polyethylene in Table 1) by chopping the film in a Waring blender, combining and extruding the resultant material (1 gram) i with poly(2-ethyl-2-oxazoline) (9 grams) as described in Example 1. The process conditions and properties of nano- and micro-fibers described in Table 1.

Higher performance polymers can be processed into miniscule fibers by extrusion with poly(2-ethyl-2-oxazoline) at higher extrusion temperatures than 140° C. Processable polymers include polyethylene, polypropylene, polylactides, polyolefins, polycycloolefins, polyesters, polycaprolactone, polyperfluorocyclobutanes, polyamides and other extrudable polymers.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making a device with a fibrous sheet, the method comprising:
combining a fiber-forming resin with a carrier resin to form a resinous mixture, the carrier resin being water soluble;
extruding the resinous mixture to form an extruded resinous mixture, the extruded resinous mixture having strands of the fiber-forming resin with the carrier resin;
contacting the extruded resinous mixture with water to separate the strands of the fiber forming resin from the carrier resin;
forming a fibrous sheet from the strands of fiber-forming resin; and
interposing the fibrous sheet between an anode and a cathode.

2. The method of claim 1 further comprising placing the fibrous sheet between an anode and a cathode wherein the fibrous sheet is a battery separator.

3. The method of claim 1 further comprising placing the fibrous sheet between a catalyst layer and a bipolar metal plate wherein the fibrous sheet is a gas diffusion layer.

4. The method of claim 1 wherein the fibrous sheet has a thickness from about 5 microns to about 2 mm.

5. The method of claim 1 wherein the fiber forming resin is a thermoplastic polymer.

6. The method of claim 1 wherein the fiber forming resin comprises a component selected from the group consisting of polyolefins, polyesters, and combinations thereof.

7. The method of claim 1 wherein the fiber forming resin comprises a component selected from the group consisting of an extrudable thermoplastic polymer such as polyethylene, polypropylene, polybutene, polybutylene terephthalate, perfluorosulfonic acid polymers, perfluorocyclobutane polymers, acrylonitrile butadiene styrene, acrylic, ethylene-vinyl acetate, ethylene vinyl alcohol, fluoropolymers, polyacrylates, polyacrylonitrile, polyaryletherketone, polybutadiene, polybutylene, polybutylene terephthalate, polycaprolactone, polychlorotrifluoroethylene, polyethylene terephthalate, polycyclohexylene dimethylene terephthalate, polycarbonate, polyhydroxyalkanoates, polyketone, polyetherketone, polyetherimide, polyethersulfone, polyethylenechlorinates, polymethylpentene, polyphenylene oxide, polystyrene, polysulfone, polytrimethylene terephthalate, polyurethane, polyvinyl acetate, polyvinyl chloride, polyvinylidene chloride, styrene-acrylonitrile, and combinations thereof.

8. The method of claim 1 wherein the carrier resin is a water-soluble polyamide.

9. The method of claim 1 wherein the carrier resin comprises poly(2-ethyl-2-oxazoline).

10. The method of claim 1 wherein the fibrous sheet has a porosity from about 5 to about 95 volume percent.

11. The method of claim 1 wherein the weight ratio of fiber resin to carrier resin is from about 0.1 to about 10.

12. The method of claim 1 wherein the strands of the fiber forming resin have an average width from about 5 nanometers to about 10 microns.

13. The method of claim 1 wherein the strands of the fiber-forming resin have an average width from about 10 nanometers to about 5 microns.

14. A method of making a device with a fibrous sheet, the method comprising:
combining a thermoplastic resin with a water-soluble polyamide resin to form a resinous mixture;
extruding the resinous mixture to form an extruded resinous mixture, the extruded resinous mixture having strands of the thermoplastic resin with the water-soluble polyamide resin;
contacting the extruded resinous mixture with water to separate the strands of the thermoplastic resin from the water-soluble polyamide resin;
forming a fibrous sheet from the strands of the thermoplastic resin; and
interposing the fibrous sheet between an anode and a cathode.

15. The method of claim 14 wherein the water-soluble polyamide resin comprises poly(2-ethyl-2-oxazoline).

16. The method of claim 15 wherein the thermoplastic resin comprises a component selected from the group consisting of polyolefins, polyesters, and combinations thereof.

17. The method of claim 14 wherein the fibrous sheet has a porosity from about 5 to about 95 volume percent.

18. The method of claim 14 wherein the weight ratio of thermoplastic resin to water-soluble polyamide resin is from about 0.1 to about 10.

19. The method of claim 14 wherein the strands of the thermoplastic resin have an average width from about 5 nanometers to about 10 microns.

20. A method of making a device with a fibrous sheet, the method comprising:
combining a thermoplastic resin with a water-soluble polyamide resin to form a resinous mixture;
extruding the resinous mixture to form an extruded resinous mixture, the extruded resinous mixture having strands of the thermoplastic resin with the water-soluble polyamide resin;
contacting the extruded resinous mixture with water to separate the strands of the thermoplastic from the water-soluble polyamide resin;
forming a fibrous sheet from the strands of the thermoplastic resin; and
interposing the fibrous sheet between an anode and a cathode.
